(19) United States
(12) Patent Application Publication
(10) Pub. No.: US 2010/0124730 A1
(43) Pub. Date: May 20, 2010

(54) ENDODONTIC OZONE APPARATUS

(76) Inventor: JURGEN H. SCHEMMER, King City (CA)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 12/271,158

(22) Filed: Nov. 14, 2008

(51) Int. Cl. A61C 5/02

(52) U.S. Cl. 433/81

(57) ABSTRACT

Endodontic ozone apparatus for the treatment of root canals includes the source of ozone, an aqueous medium, and a system for ozonating the aqueous medium. A syringe includes a needle insertable into the root canal and a plunger may be utilized for charging the syringe with ozonated aqueous medium. An ozone sensor, which may be an ink, is utilized for determining the ozone content in the aqueous medium before introduction of same into the root canal of a patient.

This invention relates to the use of ozone in the treatment of dental and oral conditions.

In order to treat a tooth that has diseased pulp material therein, it is necessary to remove the diseased pulp material from the pulp cavity, or root canal to prevent bacterial proliferation within the pulp canal of the tooth.

Subsequent to removal of diseased pulp material, the root canal is typically filled with an inert material before sealing off with an aseptic material to prevent continued or future infection of the tooth root.

It is apparent that during root canal therapy the entire root canal including the root tip, be cleaned and filled to eliminate all diseased material.

Typically, this includes opening the tooth to the pulp chamber and then manually cleaning the root canal with appropriate instruments.

Access to the pulp chamber is accomplished by drilling a hole through the tooth, which is subsequently widened for the use of endodontic instruments to large and clean the root canal to remove all the diseased pulp tissue.

Following removal, the root canal must be disinfected and dried prior to filling. A number of endodontic irrigating instruments are utilized and typically purge the root canal with a hydrogen peroxide solution or a sodium hypochloride solution.

Care in this procedure must be taken in order that the irrigating syringe is not inserted too deeply into the root canal or the pressure of the irrigating solutions to prevent flow into the apical dental formen and into the periapical area.

A further disadvantage of such irrigation is that a saliva remover must be inserted into or hanging from the mouth to extract the used irrigating solutions. This, in turn, may give discomfort to the patient and interfere with the dentist's work.

The present invention provides for disinfecting root canals through the use of ozone in an aqueous solution. Such treatment is preferred following pulp removal.

### SUMMARY OF THE INVENTION

Endodontic ozone apparatus in accordance with the present invention for the treatment of root canals generally includes a source of oxygen, an aqueous medium, a means for ozonating the aqueous medium, along with a syringe having a needle insertable into the root canal.

In addition, means are provided for charging the syringe with ozonated aqueous medium and means are provided for determining ozone content within a charged syringe. Due to the instability of ozonated water, it is important that the ozone content thereof is known before its use in irrigating root canals.

More particularly, the means for determining ozone content includes an ozone detecting ink which is disposed in the syringe in one embodiment of the present invention. It should be appreciated that any means for determining ozone content within the syringe is to be considered as part of by the present invention. Such means would include spectrographic or light transmission means. However, particularly important is the use of ozone detecting ink which enables a self-contained system with no addition exterior equipment.

In one embodiment of the present invention, the apparatus further includes a vial for receiving the aqueous medium and the means for ozonating the aqueous medium comprises a charging needle, or a line, for transferring ozone from the generator into the vial.

In this embodiment, the means for charging the syringe includes a syringe plunger for withdrawing ozonated aqueous medium from the vial via a syringe needle.

In this embodiment, the means for determining ozone content includes ozone detecting ink disposed in the vial and visible from outside of the vial.

In another embodiment of the present invention, the apparatus provides for an aqueous medium disposed in the syringe and the means for charging the syringe comprises a charging inlet disposed in the syringe connected to the source of ozone. In this embodiment, the means for determining ozone content includes an ozone detecting ink which is disposed in the syringe and visible from outside the syringe.

### BRIEF DESCRIPTION OF THE DRAWINGS

The advantages and features of the present invention will be better understood by the following description when considered in conjunction with the accompanying drawings in which:

FIG. 1 is a representation of the delivery of an ozonated aqueous medium into the root canal of a tooth via a syringe in accordance with the present invention;

FIG. 2 is an illustration of one embodiment of the present invention in which a vial is utilized. Water, or an aqueous medium, contain in the vial is ozonated through the use of an ozone generator at an interconnecting line, also shown is an ozone detecting ink disposed in the vial; and

FIG. 3 is a representation of yet another embodiment of the present invention in which an ozone generator is directly connected to a syringe with ozone detecting ink disposed in the syringe to determine ozone content.

### DETAILED DESCRIPTION

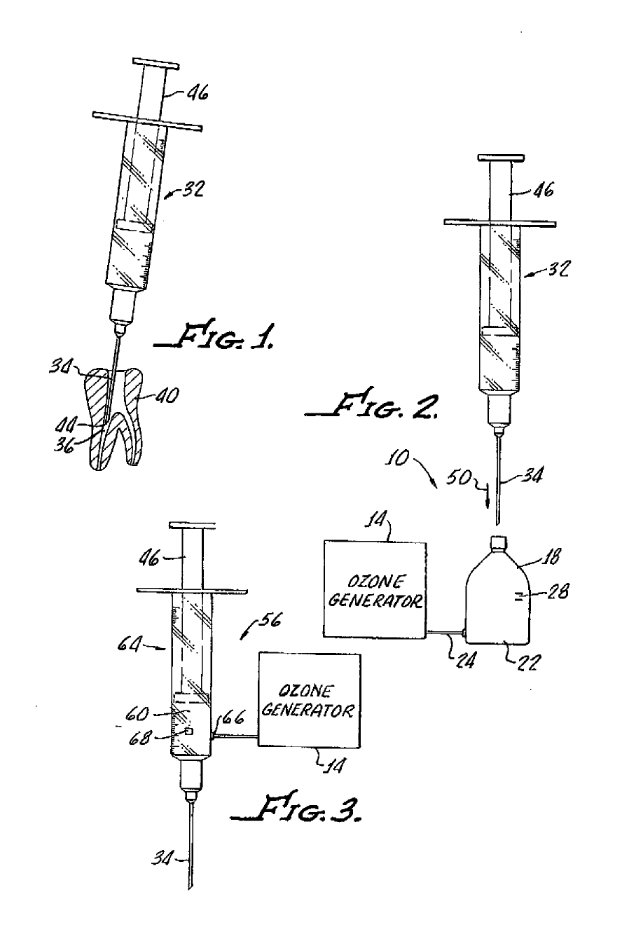

With reference to FIGS. 1 and 2, there is shown endodontic zone apparatus 10 in accordance with the present invention for the treatment of root canals as illustrated in FIG. 1.

The apparatus generally includes a source of ozone 14, which may be any suitable source, for example, as set forth in U.S. Pat. No. 7,270,460. This patent is to be incorporated herewith in its entirety for a complete description of an ozone generator 14 and system suitable for use in the present invention. A vial 18 containing an aqueous medium 22, and an interconnecting line 24 provides a means for ozonating an aqueous medium 22. Although a line 24 is shown interconnecting the ozone generator 14 and the vial 18 any suitable charging mechanism may be utilized. An ozone detecting ink 28, or sensor, is provided inside the vial 18 for determining the ozone content of the aqueous solution 22 and the vial 18. Such inks are described in U.S. Pat. No. 6,117,685 and this patent is incorporated herewith in its entirety to show an example of a means for detecting ozone content in the aqueous solution 22.

Other color metric and system such as set forth in U.S. Pat. No. 3,397,966 and U.S. Pat. No. 4,859,607 may be utilized. These patents are also incorporated herewith in their entirety to show alternate means for determining ozone content in the aqueous solution 22. Preferably, the ozone content should be between 2,000 to 9,500 ppm or more for effective antimicrobial effectiveness.

The apparatus further includes a syringe 32 having a needle 34 insertable into a root canal 36 of a tooth 40 with ozonated aqueous solution being delivered to the root canal 36 by a needle tip 44 via a plunger 46 in a conventional manner.

The plunger 46 further provides a means for charging a syringe 32 with ozonated aqueous medium 22 upon insertion of the needle into the vial 18 as indicated by the arrow 50.

Alternative embodiment 56 in accordance with the present invention is illustrated in FIG. 3 with common reference characters indicating identical or substantially similar structure shown in FIGS. 1 and 2.

In this embodiment 56, the ozone generator 14 provides ozone for ozonating aqueous medium in the syringe 64 through an inlet 66. The syringe also includes an ozone detecting ink 68 similar to the ink, or sensors 28 described in connection with the embodiment 10 shown in FIGS. 1 and 2.

After ozonating the aqueous medium 60 to satisfactory ozone connector as indicated by the ink 68, the syringe 64 utilize to irrigate the root canal 36 as shown in FIG. 1.

Although there has been hereinabove described a specific endodontic ozone apparatus in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

1. Endodontic ozone apparatus for the treatment of root canals, the apparatus comprising:
a source of ozone;
an aqueous medium;
means for ozonating the aqueous medium;
a syringe having a needle insertable into the root canal;
means for charging said syringe with ozonated aqueous medium; and
means for determining ozone content in the ozonated aqueous medium.

2. The apparatus according to claim 1 wherein said means for determining ozone content comprises an ozone detecting ink disposed in said syringe.

3. The apparatus according to claim 1 further comprising a vial for receiving said aqueous medium and said means for ozonating the aqueous medium comprising a charging line connected to said source of ozone.

4. The apparatus according to claim 3 wherein said means for charging said syringe comprises a syringe plunger for withdrawing ozonation aqueous medium from said vial via the syringe needle.

5. The apparatus according to claim 4 wherein said means for determining ozone content comprising an ozone detecting ink disposed in said vial.

6. The apparatus according to claim 1 wherein said aqueous medium is disposed in said syringe and said means for charging said syringe comprises a charging inlet disposed in said syringe and connected to said source of ozone.

7. The apparatus according to claim 6 wherein said means for determining ozone content comprises an ozone detecting ink disposed in said syringe.
